(19) United States
(12) Patent Application Publication
(10) Pub. No.: US 2023/0082291 A1
(43) Pub. Date: Mar. 16, 2023

(54) GELATIN AND PECTIN GUMMY COMPOSITION FOR STARCHLESS PRODUCTION

(71) Applicant: PHARMAVITE LLC, West Hills, CA (US)

(72) Inventors: Haiyan Ge, Valencia, CA (US); Yan Wu, Valley Village, CA (US)

(73) Assignee: PHARMAVITE LLC, West Hills, CA (US)

(21) Appl. No.: 17/985,044

(22) Filed: Nov. 10, 2022

Related U.S. Application Data
(62) Division of application No. 16/870,862, filed on May 8, 2020.

(51) Int. Cl. A23G 3/42; A23G 3/50

(52) U.S. Cl. CPC A23G 3/42; A23G 3/50

(57) ABSTRACT

A gummy composition including a gelatin; a pectin; a food-grade organic acid; and water, wherein the gummy composition has a pH of 3.1 to 3.45 or a ° Brix range of 76 to 81, and wherein the gummy composition has a removal time of 30 minutes or less in a starchless mold. A method of manufacture of a gummy composition comprising at least one of a pH of 3.1 to 3.45 and a ° Brix range of 76 to 81, and having a removal time of 30 minutes or less in a starchless mold, the method including forming a flowable composition of a gelation, a pectin, a food-grade organic acid and water; and depositing the flowable composition into a starchless mold.

### CROSS-REFERENCE TO RELATED APPLICATION

This application is a divisional of pending U.S. patent application Ser. No. 16/870,862 titled “GELATIN AND PECTIN GUMMY COMPOSITION FOR STARCHLESS PRODUCTION” filed on May 8, 2020, the content of which are incorporated herein in their entirety.

### FIELD

Nutritional compositions particularly gummy compositions and methods related thereto.

### BACKGROUND

Chewable gummy (gum) products or compositions generally made of gelatin or pectin matrix with sugar, glucose, corn syrup, flavoring, coloring and citric acid have been a popular snack food product. The product (composition) typically has a gel or gel-like structure and texture with a length on the order of two centimeters (cm) and is produced in a variety of shapes, colors and flavors that are chewable when consumed. Recently, gummy products have been supplemented with vitamins, minerals, essential oils and other nutritional supplements to provide a nutritional supplement that appeals to children and adults that do not like to swallow or have difficulty swallowing tablets or capsules.

Gummy compositions are often formed as a water-based gummy slurry of a liquid gelatin and sugar mixture. The gummy slurry is mixed at an elevated temperature (e.g., 70° C. to 100° C.) to produce a flowable liquid. The flowable liquid is poured into a mold and allowed to set. A conventional mold is a corn starch mold. A corn starch mold is formed by stamping a desired gummy shape on a tray filled with corn starch powder. Once in the mold, the gummy composition is then cooled to a point where at least an outer portion of the gummy composition has gelled (partially solidified). After the gummy composition has set, the tray is tipped over, breaking the mold and separating the gelled gummy composition from the corn starch. The starch mold generally functions to reduce a temperature of the gummy composition and to absorb water from the gummy. Both help with the gummy solidification. Usually it takes about 24 hours for the gummy composition to completely set with a “set time” defined as the time it takes for a gummy composition to form a firm gelled structure throughout—from an outer surface to a midpoint when measured on each side or face. Once the gummy composition has set, any exterior surface of the gummy composition may be destarched and coated (for example with carnauba wax).

Starchless production of gummy compositions offers advantages such as good hygiene and generally fast setting (gelation) over conventional production. An example of a starchless mold is a silicone mold. Despite the advantages, making gelatin-based gummy compositions (gelatin as structurant) in starchless molds presents challenges as the gelatin-based gummy compositions cannot be as easily removed from starchless molds as starch molds and gelatin-based gummy compositions may require long removal (gelation) time—(e.g., 90 minutes or more) before they can be processed further. One study showed that a gummy composition with pectin as the sole structurant required less time (e.g., one minute to 20 minutes) to become removable from a silicone mold, with removal time defined as the time required for all sides of a gummy composition to be easily separated from the mold by pushing the gummy composition out of the mold from the back of the mold. A gummy composition with pectin as the only structurant, however, tends to be a composition that has a more brittle, less chewy texture than that of a gelatin-based gummy composition preferred by most consumers.

### BRIEF DESCRIPTION OF THE DRAWINGS

FIG. 1A shows a graphical representation of a texture profile analysis of a gummy composition.

FIG. 1B shows a storage modulus curve and a loss modulus curve for a gummy composition during a temperature ramp down from 85° C. to 25° C. at 1° C./minute.

FIG. 2 shows a three-dimensional graphical representation of removal time—of a gummy composition with 1.5 weight percent pectin and with 0.8 weight percent pectin.

FIG. 3 shows graphical representations of gelling temperature of a gummy composition with two weight percent and with one weight percent citric acid solution (50 percent citric acid solution).

### DETAILED DESCRIPTION

A gummy or gum composition for oral consumption is disclosed. The gummy composition is formed of a combination of gelatin and pectin as structurants. The gummy composition may have one or more supplements or active agents therein, including but not limited to one or vitamins, one or more minerals, one or more herbs, one or more pharmaceutical and/or one or more nutritional supplement such as protein, beneficial oils (e.g., fish oil including krill oil, triglycerides, etc.), hormones (e.g., melatonin), antioxidants (e.g., CoQ10), phytosterols.

By investigating the relationship between gelatin and pectin along with a food grade organic acid and water to the properties of a gummy composition, the gummy composition may be consistently produced in a starchless mold to have a removal time of 30 minutes or less while providing a texture and appearance acceptable to consumers. A “removal time,” “removable time” or “release time” as used herein is a time that it takes for at least an outer portion of a gummy composition to gel so that the gummy composition may be removed from a starchless mold as a single unit. A “set time” as used herein is defined as the time it takes for a gummy composition to form a firm gelled structure throughout—from an outer surface to a midpoint when measured on each side or face. A set time for a gummy composition is generally longer than a removal time. For gummy compositions, a removal time is directly related to a set time. Therefore, a reduction in a removal time will result in a reduction in a set time and an increase in the efficiency of a gummy composition manufacture process. In addition to a removal time using a starchless mold (e.g., a silicone mold) of 30 minutes or less, a gummy composition may have a hardness of 4000 gForce or less when measured as a peak force to compress a gummy composition having a thickness of 0.9 centimeters and a square shape (2.0 centimeters by 2.0 centimeters) by 50 percent or 4.5 millimeters (50% compression by distance) in a set state at 0.5 millimeters per second by a TA-25 probe (2 inch in diameter and 20 mm tall). A representative hardness is 2500 gForce to 4000 gForce, 3300 gForce to 3900 gForce and 3500 gForce to 3800 gForce.

A gummy composition may have a water activity below 0.7 such as in a range of 0.6 to 0.7, 0.62 to 0.7, 0.65 to 0.7, 0.67 to 0.7 or 0.67 to 0.69. A gummy composition may also have a solid content of 81 percent or less (81° Brix), such as 76 to 81° Brix, such as 77-80° Brix, such as 76° Brix, 77° Brix, 78° Brix or 79° Brix. A representative pH of a gummy composition may be between 3.10 to 3.45, such as 3.20 to 3.40.

A gummy composition may include water, gelatin, pectin and a food grade organic acid or acids along with a sugar, a corn syrup, a flavorant and a colorant. The gelatin may be a gelatin having a bloom greater than 250 (a “high bloom gelatin”), such as in a range of 255 bloom to 300 bloom, a range of 260 bloom to 300 bloom or a range of 270 bloom to 300 bloom. The pectin may be a high methoxy (HM) pectin (degree of esterification or DE° above 50%).

A gummy composition may include water in an amount of 14.4 percent by weight of the composition to 15.2 percent by weight of the composition; gelatin (e.g., a high bloom gelatin) in an amount of 5.1 percent by weight of the composition to 5.6 percent by weight of the composition; HM pectin in an amount of 0.8 percent by weight of the composition to 1.3 percent by weight of the composition and 50 percent by weight of a food-grade organic acid or acids solution in an amount of 1.9 percent by weight of the composition to 2 percent by weight of the composition. Suitable food-grade organic acids include citric acid, lactic acid, fumaric acid, malic acid, ascorbic acid and tartaric acid. In one example, the food-grade organic acid may be a 50 percent by weight citric acid solution alone or in combination with another food-grade organic acid.

A gummy composition may be formed by forming a slurry of a gelatin, a pectin, a food-grade organic acid or acids and water. The gummy slurry is mixed at an elevated temperature (e.g., 70° C. to 90° C.) to produce a flowable liquid. The flowable liquid is poured into a starchless mold for a removal time of 30 minutes or less. More specifically, the gelatin and the pectin may be separately hydrated in water to form a first slurry and a second slurry and the slurries combined into a single slurry that is deposited into the starchless mold. The second slurry of pectin may include a sugar and a corn syrup or corn syrups. As an alternative to forming two separate slurries then combining the solutions, a method more specifically may include hydrating the pectin and adding the gelatin in a solid form, a sugar and a corn syrup to the hydrated pectin.

As described above, by understanding a relationship between the structurants (gelatin and pectin) to the properties of a gummy composition along with a relationship between the structurants (gelatin and pectin) and food-grade organic acid or acids and water to the properties of a gummy composition, a gummy composition may be consistently produced using a starchless mold that has a removal time of 30 minutes or less while providing a texture and appearance acceptable to consumers.

Table 1 presents representative gummy composition formulations including a structurant of gelatin alone (Batch 001) and a structurant of gelatin and pectin (Batch 002 and Batch 003). The compositions were formed and then deposited in a silicone (starchless) mold for setting. Table 2 shows the physical properties of the representative formulations of Table 1. Table 2 shows that by adding pectin to the gelatin gummy formulation, a set time in a starchless mold is reduced illustrated by a reduction in removal time from 90 minutes for Batch 001 (no pectin) to 20 minutes (Batch 002). The removal time presented in Table 2 was established by pushing gummy composition samples out from the back of a silicone mold and confirming that all sides of the samples were separated from the mold.

Table 2 also indicates that once a pectin to gelatin ratio is too high, the resulting gummy structure became dominated by pectin and the hardness significantly increased (Batch 003). Batch 002 has approximately five times the amount (as measured by weight percent) of gelatin relative to pectin whereas Batch 003 has approximately equal amounts of gelatin and pectin. The increased ratio of pectin in Batch 003 results in a harder gummy composition after setting. Therefore, it is crucial to understand the proper range of gelatin and pectin in gummy formulations for starchless production and the how these and other ingredients affect a gummy composition manufacturing process, physical and sensory properties.

TABLE 1
Examples of Gelatin and Pectin and Gelatin Batches

| Ingredients | 001 | 002 | 003 |
|---|---|---|---|
| Water | 4.50% | 8.23% | 9.15% |
| 58-65% DE° Pectin | 0.00% | 1.46% | 1.64% |
| (Herbstreith & Fox) | | | |
| 270 Bloom Gelatin (Gelita) | 7.52% | 7.46% | 1.62% |
| Sugar | 38.12% | 40.98% | 41.45% |
| 43 DE corn syrup (Cargill) | 0.00% | 0.00% | 0.00% |
| 63 DE corn syrup (Cargill) | 47.16% | 39.17% | 43.44% |
| 50% citric acid solution | 2.20% | 2.20% | 2.20% |
| Color (Chr Hansen) | 0.10% | 0.10% | 0.10% |
| Flavor (Virginia Dare) | 0.40% | 0.40% | 0.40% |
| Total | 100.00% | 100.00% | 100.00% |

TABLE 2
Process and Physical Properties of Formulations of Table 1

| | Removable | | Water | Hardness ^{d} |
|---|---|---|---|---|
| Batch #: | time (min) | °Brix ^{b} | activity ^{c} | (gForce) |
| 001 | 90 | 83 | 0.62 | 1187 |
| 002 | 20 | 78 | 0.68 | 2249 |
| 003 | 5 | 80 | 0.63 | 4707 |

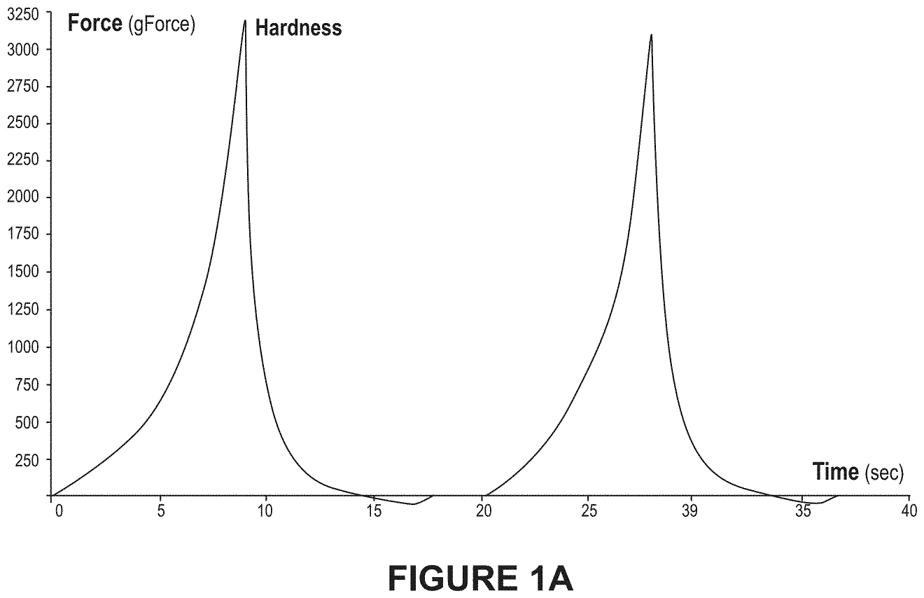

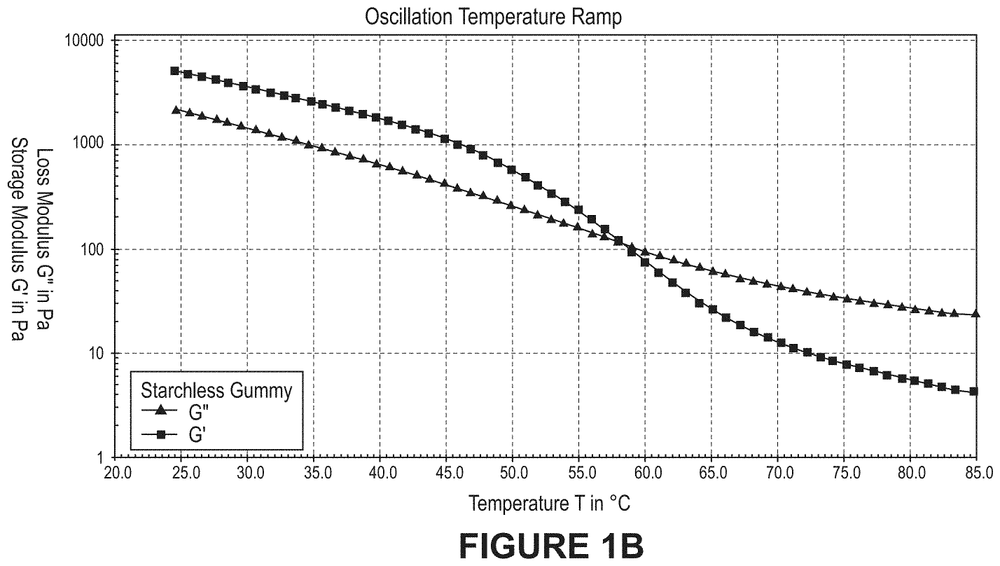

After gummy composition samples are removable from a starchless mold, the samples were removed from the mold and allowed to sit in room air for 24 hours before the following physical property tests were performed: ° Brix (Atago handheld refractometer), water activity (Aqualab 4TE water activity meter) and hardness (Texture Analyzer from Stable Micro Systems). For the hardness analysis, a double compression test was performed using a TA-25 cylinder probe (diameter 2 inches and height 20 mm). The test was conducted by compressing 4.5 millimeter (mm) from a surface of a sample with the probe at 0.5 mm per second, then returning to the original position at the same speed, followed by a one second resting then repeating the compressing and returning with the same conditions. A peak force at the first peak was measured as the hardness (FIG. 1A).

Research showed that amounts of sugar and corn syrups or their types had no significant impact on removable (set) time of gummies after depositing in a starchless mold as long as the final ° Brix was around 78 or above. Therefore, a Mixture Design of Experiment (DOE) was designed in which sugar, syrups, flavor and color were kept constant or the same weight percentage in a gummy formulation and water, pectin, gelatin and food-grade organic acid (citric acid) were varied. The weight percentages of the constant ingredients in a gummy formulation were: sugar 37.0%, 43 DE syrup 18.5%, 63 DE syrup 21.0%, mixed berry flavor 0.4%, and color 0.1%. Based on some preliminary results and literature review, the variable ingredients were treated as variables with the weight percent ranges set forth in Table 3.

TABLE 3
DOE Variable Ingredients and Weight Percentage Ranges

| Ingredients | Units | Minimum | Maximum |
|---|---|---|---|
| Water | wt % | 10.6 | 18.8 |
| 58-65% DE° Pectin (Herbstreith & Fox) | wt % | 0.7 | 1.5 |
| 270 Bloom Gelatin (Gelita) | wt % | 4.6 | 6.8 |
| 50% Citric acid solution | wt % | 1 | 2 |
| | | Total = | 23.0 |

Twenty DOE batches were designed and conducted, and gummy removable time, gelling temperature, ° Brix, water activity, pH, accelerated heat stability, texture profile were tested. Table 4 shows two examples of the DOE batches. Table 5 shows process and physical properties of the two examples.

For all batches, the gelatin was hydrated (Caframo Overhead Mixer) in water with 1:2 weight ratio first at about 85° C. for 15 minutes and then defoamed in an oven overnight at 70° C. At the beginning of the procedure, pectin powder was first blended with sugar at a ratio of 1:5 before being mixed into pre-heated deionized (DI) water. The solution was then heated to 90° C. and maintained for 10 minutes while mixing. Pre-heated corn syrups were then added to the batch and mixed until homogeneous. Once the temperature reached to 90° C., the remainder of sugar was added to the mixture and the mixture was maintained at 90° C. for another 10 minutes. The temperature was then increased to 110° C. and intensive bubbling started to occur to dissolve the sugar. The mixture was then cooled to 100° C. and a final ° Brix around 84 was confirmed. A portion of the mixture was measured and transferred to a new beaker and maintained at around 85° C. The defoamed gelatin hydration was then added, followed by additions of color, flavor and 50 percent citric acid solution. The temperature of the slurry was maintained around 85° C. and the in-line pH was measured by an Oakton pH meter. An in-line pH measurement was found to correspond to a pH measurement of a set gelatin-pectin gummy composition at 30° C. done by combining the set gummy composition at a 1:1 weight ratio with water then heating to dissolve the gummy composition followed by cooling to 30° C.

After gummy samples were ready for depositing, a portion of gummy slurry was immediately transferred to a rheometer (Anton Paar MCR 302) for rheological test using CC27 measuring system. The rheological test was performed with a pre-shear speed at 300 radian per second for one minute, followed by a temperature ramp decrease from 85° C. to 25° C. at 1° C. per minute with an amplitude strain at 5 percent and a frequency at 10 radian per second. The gelling temperature was measured by identifying the temperature when the storage modulus curve crossed the loss modulus curve (FIG. 1B).

Soon after gummy samples were deposited, the removal time was evaluated by pushing gummy composition samples out from the back of a silicone mold and evaluating whether all sides of the samples were separated from the mold. After gummy composition samples are removable, the samples were removed from the mold and allowed to sit in room air for 24 hours before the following physical property tests were performed: ° Brix (Atago handheld refractometer), water activity (Aqualab 4TE water activity meter) and texture profile (Texture Analyzer from Stable Micro Systems). For the texture profile analysis, a double compression test was performed using a 25 mm round flat probe. The test was conducted by compressing 4.5 millimeter (mm) from a surface of a sample with the probe at 0.5 mm per second, then returning to the original position at the same speed, followed by a one second resting then compressing again with the conditions. The peak force at the first peak was measured as the hardness (FIG. 1A). A cohesiveness was calculated as the area of the second peak divided by the area of the first peak (FIG. 1A). The springiness was calculated as the compression distance of the second peak divided by the compression distance of the first peak (FIG. 1A). The chewiness was calculated as hardness×cohesiveness×springiness.

For an accelerated heat stability study, the samples were packed into bottles and put into 40° C./75 percent relative humidity (RH %) stability chamber. The sample appearance after seven days was evaluated after the samples were removed from the chamber and returned to room temperature. For this DOE, gelatin hydration was made separately first and defoamed to reduce process variables. In other batch process, gelatin powder can be added into the hydrated pectin solution directly at temperature around 85-95° C. to hydrate. Sugar and corn syrup are added afterwards. The rest of the procedures are the same as DOE batches.

TABLE 4
Batch Examples Created after the DOE modeling

| Ingredients | B001 | B002 |
|---|---|---|
| Water | 14.88% | 9.25% |
| 58-65% DE° Pectin (Herbstreith & Fox) | 1.39% | 1.50% |
| 270 Bloom Gelatin (Gelita) | 4.74% | 5.55% |
| 50% citric acid solution | 1.99% | 1.94% |
| Sugar | 37.00% | 37.00% |
| 43 DE corn syrup (Cargill) | 18.50% | 18.50% |
| 63 DE corn syrup (Cargill) | 21.00% | 21.00% |
| Red Color (Chr Hansen) | 0.10% | 0.10% |
| Mixed Berry Flavor (Virginia Dare) | 0.40% | 0.40% |
| Total | 100.00% | 100.00% |

TABLE 5
Process and Physical Properties of DOE Batch Examples

| | | | Gelling | | | | |
|---|---|---|---|---|---|---|---|
| | Removable | pH | Temperature | Brix | Water | Hardness | Chewiness |
| Batch #: | time (min) | (In-line) | (° C.) | (%) | activity | (gForce) | (gForce) |
| B001 | 10 | 3.15 | 57.03 | 80 | 0.67 | 4653 | 3536 |
| B002 | 15 | 3.22 | 43.82 | 78 | 0.69 | 4905 | 3690 |

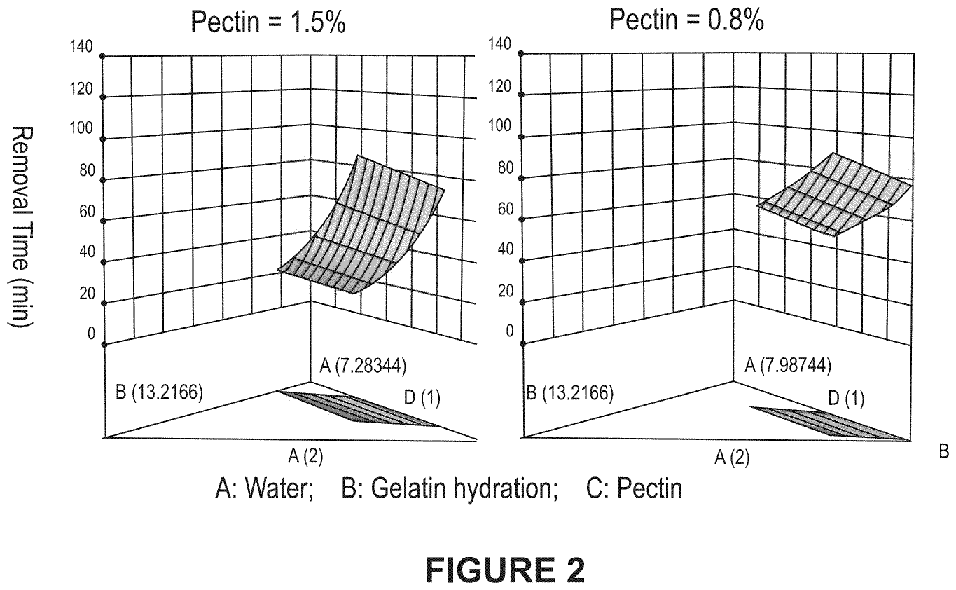

The DOE analysis showed that the minimum time required for gummy compositions to become removable from a starchless mold largely depends on food-grade organic acid (e.g., citric acid) and pectin contents and their interaction. FIG. 2 graphically shows that decreasing a weight percentage of pectin in a gummy composition from 1.5 percent to 0.8 percent, for example, increases the resulting removable time greatly.

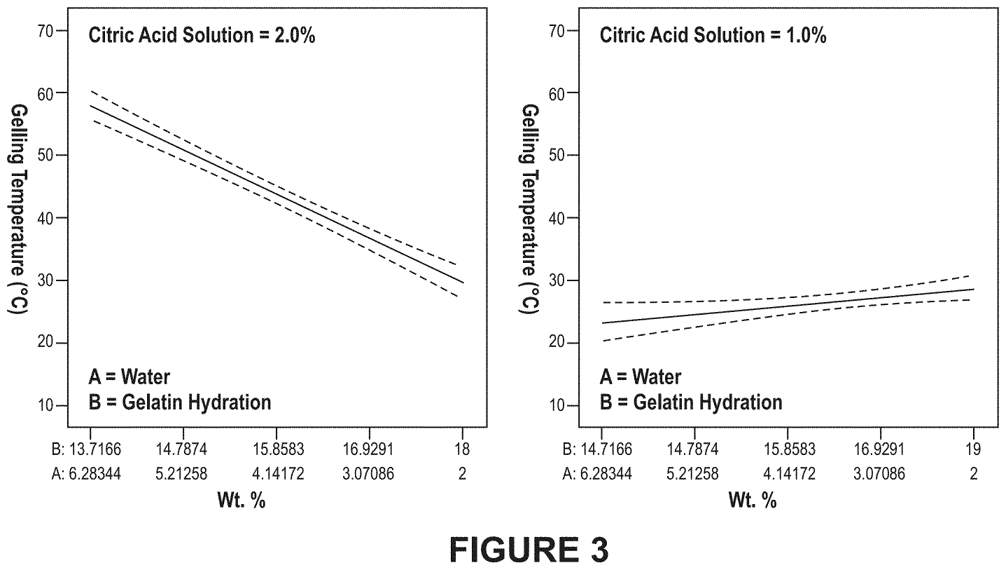

The DOE also showed that a gummy composition gelling temperature was greatly affected by the food-grade organic acid contents. FIG. 3 shows that decreasing a 50 percent citric acid solution weight percentage in a gummy composition from two percent to one percent significantly reduced a gelling temperature of the gummy composition.

The DOE further showed that each of the variable components (water, gelatin, pectin, food-grade organic acid) contribute to pH and water activity closely.

The DOE still further showed that gummy composition hardness and chewiness were largely affected by the food-grade organic acid and pectin contents.

Formulations (Batches B001 and B002) were created using the developed models from the DOE targeting an ideal removable time of 20 minutes. The resulting removable time (shown in Table 6) were in alignment with the predictions from the models, indicating their reliability. In general, high levels of food-grade organic acid (e.g., citric acid solution) and pectin, and low-intermediate level of gelatin are recommended for minimal removable time.

It is known that the bloom index of gelatin affects setting of gummy samples after deposition. All 20 DOE batches used gelatin with 270 bloom index. To evaluate the potential impact from bloom index on gummy setting, additional batches (Batches B003 and B004) were made by using the same formulations as in previous batches (e.g., Batches B001 and B002) but replacing the 270 bloom gelatin with 250 bloom gelatin. It was observed that decreasing the gelatin bloom index in formulations significantly increased the minimum time required to remove gummies from the mold after depositing. Thus, formulations using higher bloom gelatin is preferred for starchless gummy production.

TABLE 6
Gummy Compositions Using 270 Bloom Gelatin Or 250
Bloom Gelatin and the Resulting Removable Time

| Ingredients | B001 | B002 | B003 | B004 |
|---|---|---|---|---|
| Water | 14.88% | 14.02% | 14.88% | 14.02% |
| 58-65% DE° Pectin | 1.39% | 1.50% | 1.39% | 1.50% |
| (Herbstreith & fox) | | | | |
| 270 Bloom Gelatin | 4.74% | 5.55% | 0.00% | 0.00% |
| (Gelita) | | | | |
| 250 Bloom Gelatin | 0.00% | 0.00% | 4.74% | 5.55% |
| (Gelita) | | | | |
| 50% citric acid solution | 1.99% | 1.94% | 1.99% | 1.94% |
| Sugar | 37.00% | 37.00% | 37.00% | 37.00% |
| 43 DE corn syrup | 18.50% | 18.50% | 18.50% | 18.50% |
| (Cargill) | | | | |
| 63 DE corn syrup | 21.00% | 21.00% | 21.00% | 21.00% |
| (Cargill) | | | | |
| Red Color (Chr Hansen) | 0.10% | 0.10% | 0.10% | 0.10% |
| Mixed Berry Flavor | 0.40% | 0.40% | 0.40% | 0.40% |
| (Virginia Dare) | | | | |
| Total | 100% | 100% | 100% | 100% |
| Removable Time (min) | 10 | 15 | 120 | 75 |

It was observed that each of the four variable components in the DOE affected process and physical properties of gummy samples. In particular, citric acid solution, pectin, and/or their interaction had significant impact on removable time, gelling temperature, hardness, and chewiness. To achieve fast setting, low to intermediate level of gelatin hydration (for example, a range of 15.3 weight percent to 16.8 weight percent) and relatively high levels of pectin and citric acid are recommended. In addition, gelatin with a bloom index of 270 or more is recommended for faster setting. On the other hand, sensory analysis showed that formulations with high citric acid solution level and low-intermediate levels of pectin and gelatin solutions had a higher probability to achieve high overall liking scores. Therefore, for starchless production of gummy compositions, a combination of pectin and high bloom gelatin, a relatively high level of citric acid solution, and relatively intermediate levels of pectin and gelatin are recommended to achieve preferred sensory scores and faster setting.

Based on the DOE, sensory attributes and overall liking, a gummy composition formulation for manufacture in a starchless mold (e.g., a silicone mold) may have the formulation set forth in Table 7.

TABLE 7
Gummy Composition Formulation

| Ingredients | Weight Percent (Wt %) | Example Wt % |
|---|---|---|
| Water | 13.1-16.5 | 14.4-15.2 |
| HM Pectin | 0.5-1.5 | 0.8-1.3 |
| 270 Bloom Gelatin | 4.5-6.0 | 5.1-5.6 |
| 50% citric acid solution | 1.5-2.4 | 1.9-2.0 |
| Sugar | 30.0-40.0 | 34.0-39.0 |
| Corn syrups | 35.0-45.0 | 35.0-41.0 |
| Color | 0.05-0.50 | 0.05-0.30 |
| Flavor | 0.10-1.00 | 0.20-0.50 |

A gummy composition that will have a removal time of 30 minutes or less may have a pH in the range of 3.1-3.45, such as 3.2 to 3.4; a ° Brix range of 76 to 81, such as 77 to 80 and a hardness range of 2500 gForce to 4000 gForce.

Table 8 shows an example of a gummy composition formulation for starchless mold. Table 9 shows the process and physical properties of a gummy composition using the gummy composition formulation in Table 8 in a starchless mold manufacturing process.

TABLE 8
Gummy Composition Batch

| Ingredients | B005 |
|---|---|
| Water | 14.87% |
| 58-65% DE° Pectin (Herbstreith & fox) | 0.97% |
| 270 Bloom Gelatin (Gelita) | 5.16% |
| 50% citric acid solution | 2.00% |
| Sugar | 37.00% |
| 43 DE corn syrup (Cargill) | 18.50% |
| 63 DE corn syrup (Cargill) | 21.00% |
| Red Color (Chr Hansen) | 0.10% |
| Mixed Berry Flavor (Virginia Dare) | 0.40% |
| Total | 100.00% |

TABLE 9
Process and Physical Properties of Composition Based
on the Gummy Composition Formulation in Table 8

| | |
|---|---|
| °Brix | 78 |
| Removal time (min) | 30 |
| pH (In-line) | 3.34 |
| Gelling Temperature (° C.) | 49.91 |
| Water activity | 0.67 |
| Hardness (gForce) | 3762 |
| Chewiness (gForce) | 2942 |

Two batches were designed and conducted to investigate potential impact of supplements or active ingredients on physical properties of gummy composition samples. Table 10 shows formulations of the batches. Batch C001 is a formulation with addition of Vitamin D3 at the common dosage level for gummy products. Batch C002 is a formulation with Biotin and Vitamin C (ascorbic acid and sodium ascorbate) at the common dosage level for gummy products.

TABLE 10
Gummy Composition Formulations With Active Ingredients

| Ingredients | C001 | C002 |
|---|---|---|
| Water | 13.28% | 11.99% |
| 58-65% DE° Pectin (Herbstreith & fox) | 1.50% | 1.50% |
| 270 Bloom Gelatin (Gelita) | 5.55% | 5.55% |
| 50% citric acid solution | 1.94% | 1.40% |
| Sugar | 37.00% | 37.00% |
| 43 DE corn syrup (Cargill) | 18.50% | 18.50% |
| 63 DE corn syrup (Cargill) | 21.00% | 21.00% |
| Color (Chr Hansen) | 0.10% | 0.10% |
| Flavor (Virginia Dare) | 0.40% | 0.40% |
| Vitamin D-3 (BASF) | 0.73% | 0.00% |
| Biotin (U.S. Pharma Lab) | 0.00% | 0.50% |
| Ascorbic Acid (Prinova) | 0.00% | 1.72% |
| Sodium Ascorbate (DSM) | 0.00% | 0.34% |
| Total | 100% | 100% |

For these two batches, the process to make the main batch (the gummy composition) is the same as previous batch examples without an active. For Batch No. C001, the vitamin D premix was prepared by adding vitamin D powder into the mixer of corn syrup and deionized water at 60° C. and then mixing it for about 15 minutes at 60° C. to suspend it uniformly. The vitamin D premix was added into the main batch while mixing followed by additions of color, flavor and 50 percent citric acid solution at around 85° C. The gummy slurry was deposited into silicone mold. For Batch No. C002, the premix of biotin and vitamin C was made by dissolving ascorbic acid, sodium ascorbate in deionized water first at 60° C. while mixing and then suspending biotin powders into the dissolved solution. The premix of biotin and Vitamin C was then added into the main batch at about 85° C. followed by additions of color, flavor, and 50% citric acid solution before the gummy slurry was deposited into silicone mold. Gummy removable time, ° Brix, water activity, pH, and texture profile were tested using the same procedures as discussed above.

TABLE 11
Process and Physical Properties of the
Two Batches With Active Ingredients

| | Removable | pH | | Water | Hardness | Chewiness |
|---|---|---|---|---|---|---|
| Batch #: | time (min) | (In-line) | °Brix | activity | (gForce) | (gForce) |
| C001 | 10 | 3.45 | 81.0 | 0.67 | 3492 | 2712 |
| C002 | 15 | 3.33 | 78.8 | 0.69 | 4603 | 3595 |

It was observed that addition of common fat soluble and water-soluble vitamins at the described amounts did not significantly affect the key physical and process properties of starchless gummy formulations.

Table 12 shows the measured ° Brix, water activity and pH of four commercially available gummy composition products that use both gelatin and pectin as structurants, the results were averaged from three individual measurements. To measure the pH of these products, the gummy composition was combined in a 1:1 weight ratio with warm deionized water and heated to dissolution. The pH was measured at 30° C. A notable difference in the four commercially available gummy composition products relative to the gummy compositions described herein is a higher pH as well as a higher ° Brix value in the commercially available gummy composition products. Given these higher values of pH and ° Brix, these commercially available gummy composition products would likely not be suitable for a starchless production process.

TABLE 12
Commercially Available Gummy Compositions With Gelatin
and Pectin and Their Measured Properties

| | | Water | pH at |
|---|---|---|---|
| Product Name (Brand) | °Brix | activity | 30° C. |
| MultiVites (VitaFusion) | 84.3 | 0.68 | 4.21 |
| Women's Formula (Smarty Pants) | 83.0 | 0.63 | 3.60 |
| Sleep (Oily) | 82.0 | 0.71 | 3.65 |
| Hair, Skin, and Nails | 81.3 | 0.71 | 3.55 |
| (Nature's Bounty) | | | |

Batches were further designed and conducted to investigate potential impact from different food-grade organic acids on physical properties of gummy compositions. Table 13 shows formulations of the batches. Batch D001 was a formulation using 50% citric acid solution. Batch D002 and D003 were the same formulation using 50% malic acid solution and a mixture solution of 25% citric acid and 25% malic acid, respectively.

TABLE 13
Formulations With Different Acids

| Ingredients | D001 | D002 | D003 |
|---|---|---|---|
| Water | 15.00% | 15.00% | 15.00% |
| Pectin (Herbstreith & fox) | 1.50% | 1.50% | 1.50% |
| 270 Bloom Gelatin (Gelita) | 5.53% | 5.53% | 5.53% |
| 50% citric acid solution | 1.94% | 0% | 0.97% |
| 50% malic acid solution | 0% | 1.94% | 0.97% |
| Sugar | 37.00% | 37.00% | 37.00% |
| 43 DE corn syrup (Cargill) | 18.50% | 18.50% | 18.50% |
| 63 DE corn syrup (Cargill) | 21.00% | 21.00% | 21.00% |
| Color (Chr Hansen) | 0.10% | 0.10% | 0.10% |
| Flavor (Virginia Dare) | 0.40% | 0.40% | 0.40% |
| Total | 100% | 100% | 100% |

TABLE 14
Process and Physical Properties of the Three
Batches of Table 13 With Different Acids

| | pH | Removable | Brix | Water | Hardness | Chewiness |
|---|---|---|---|---|---|---|
| Batch #: | (In-line) | time (min) | (%) | activity | (gForce) | (gForce) |
| D001 | 3.22 | 15 | 78.5 | 0.69 | 4905 | 3690 |
| D002 | 3.39 | 20 | 81.0 | 0.69 | 4051 | 3358 |
| D003 | 3.39 | 20 | 80.5 | 0.70 | 3460 | 2916 |

It was observed that replacing citric acid with malic acid or a combination of citric acid and malic acid did not significantly affect the key physical and process properties of starchless gummy formulations.

What is claimed is:

1. A method of manufacture of a gummy composition comprising at least one of a pH of 3.1 to 3.45 and a ° Brix range of 76 to 81, and having a removal time of 30 minutes or less in a starchless mold, the method comprising:
forming a flowable composition of a gelation, a pectin, a food-grade organic acid and water; and
depositing the flowable composition into a starchless mold.

2. The method of claim 1, wherein the food-grade organic acid comprises a 50 percent citric acid solution present in the gummy composition in amount of 1.9 weight percent to 2 weight percent of the gummy composition.

3. The method of claim 1, wherein the pectin is present in an amount of 1.3 percent by weight of the composition or less.

4. The method of claim 1, wherein the gelatin has a bloom greater than 250 and is present in an amount of 5.6 percent by weight of the composition or less.

5. The method of claim 1, wherein forming the solution comprises forming a first solution comprising the pectin, a sugar and a corn syrup and a second solution comprising the gelatin and combining the first solution and the second solution.

6. The method of claim 1, wherein forming the flowable composition comprises hydrating the pectin and adding the gelatin in a solid form, a sugar and a corn syrup to the hydrated pectin.
